(19) United States
(12) Patent Application Publication
(10) Pub. No.: US 2024/0155980 A1
(43) Pub. Date: May 16, 2024

(54) CULTIVATION/GROW TABLES, MODULAR CONTAINER GROW FACILITIES/COMPLEXES, GROW SYSTEMS, AND USES THEREOF

(71) Applicants: Richard Lavern Busz, Venice, FL (US); Shoreline Power Services, Inc., Williamsburg, MI (US)

(72) Inventor: Richard Lavern Busz, Venice, FL (US)

(21) Appl. No.: 18/389,533

(22) Filed: Nov. 14, 2023

Related U.S. Application Data
(60) Provisional application No. 63/425,234, filed on Nov. 14, 2022.
(60) Provisional application No. 63/548,152, filed on Nov. 10, 2023.

(51) Int. Cl. A01G 9/14; A01G 9/02; A01G 9/24; A01G 9/26

(52) U.S. Cl. CPC A01G 9/1423; A01G 9/023; A01G 9/246; A01G 9/247; A01G 9/249; A01G 9/26; A01G 9/18

(57) ABSTRACT

A single or two-tier growing table is disclosed. An assembly of 2 or more modular container units that include one or several rows of single-tiered, two-tiered, or multi-tiered growing tables, or a combination thereof, is also presented. An assembly of modular container units may be joined to each other with a stable seal and flange connection system, and provide an easily assembled modular plant facility. Each modular container unit will include a unit suitable to maintain individual constant temperature/humidity control, an air filtration system (odor/fumes/cross-contamination control), a CO2 enrichment system, an irrigation system, a lighting system, and other control/maintenance components/apparatus. An electrically controlled multi-lighting source (light trellis system) is provided, and may be incorporated onto an adjustable second level platform/shelf of the two-tiered growing table, and permits adjustment of the height of each shelf to accommodate individual plant heights. Wheels at the underside of the grow table provide improved maneuverability/accessibility.

### CROSS-REFERENCE TO RELATED APPLICATIONS

This application is a U.S. Nonprovisional patent application and claims priority to U.S. Provisional Patent Application No. 63/425,234, filed Nov. 14, 2022, and U.S. Provisional Patent Application No. 63/548,152, filed Nov. 10, 2023, all of which are hereby incorporated by reference in their entirety as though fully set forth herein.

### FIELD OF THE INVENTION

The present invention is related to the field of apparatus and/or modular containers and/or units, and combinations of two or more of the modular containers, in plant cultivation and plant growth facilities. The invention also relates to the field of mobile plant platform units and/or plant grow tables for cultivation, growth and/or processing of plants and/or plant materials.

### BACKGROUND OF THE INVENTION

Cultivation of specialty plant crops and/or different plant types, including cannabis, remains limited. In part, suitable mature plant production levels remain unsatisfactory for growers in the increasingly competitive field of specialty, commercially valuable, plant products. Conventional systems are cost prohibitive, as they fail to provide satisfactory commercial scale production of plant material, are not mobile, do not provide economic cost of construction and/or assembly, require real estate land site acquisition, are not suitable for disassembly/reassembly for user/grower relocation needs.

The art remains in need of improved apparatus, methods and modular systems to satisfy these and other needs of the user/grower, that are cost-effective, durable, amenable to assembly/disassembly, and that do not require permanent investment in a suitable real estate site.

### SUMMARY OF THE INVENTION

The present invention meets the above needs, among others, for improved modules and systems for plant cultivation, especially for cultivation/growth of commercially valuable, specialty plants. For example, the specialty plant cultivation of cannabis with the apparatus, devices, modules and methods described herein, is provided having significant advantages and improvements over existing grow systems.

The specialty modified modular containers may employ shipping containers of virtually any size, and customized for the particular uses and applications disclosed herein, so as to provide a grow facility and/or grow complex at reduced cost/expense to a user, that comprises two or more of the modified modular containers without conventional and permanent brick and mortar on a fraction of the land space typical to a commercial plant grow facility.

Single-Tier Grow Table and/or Single-Tier Grow Platform:

In one aspect, a mobile, single tier grow table and/or grow platform is provided, having one level and/or plant platform suitable for placing plants (FIG. 11). The plant platform for plant placement is designed so as to include an irrigation and/or flooding watering means within a base structure. The platform upon which plants may be placed remains stationary. The platform may include a plant tray or other tray/carrier that may be useful for moving several plants placed on the platform. In some embodiments, the grow table platform will remain stationary. In other embodiments, the Tier Grow Table will include a light source, such as light sources (fixtures) incorporated onto a trellis located at a top end of the single tier grow table. The light and trellis assembly may be adjustable up and down automatically by operation of a button controlled winch.

In some embodiments, the single tier grow table will have a dimension of about 12 feet long (or 36 feet long) by 4 feet wide, and having a depth of about 4 inches.

### Assembly of Two or More Single-Tier Grow Tables—

The single-tier grow tables may be joined together to provide a row, or assembly, of single-tier grow tables. The grow tables may include a light source suitable for providing light to plants located on the plant platform. The light source may be provided as pendant lights from the top of each of the individual single tier grow tables, such as light fixtures or lights hanging on a trellis. The trellis support poles of the assembly may include lights attached to the trellis frame, such as to enable multiple lights to be raised and lowered at once over the interior of the grow table. The trellis provides a structure suitable for moving all or some of the lights thereon up and down as part of the grow table, and may be powered by the touch of a switch button to activate a winch. The winch-controlled switch button may be provided as a pendant switch button for easier access by a user.

The single tier grow tables may be provided and built for commercial sale (built and sold) without a trellis frame. In this embodiments, the lights sources (fixtures) may be hung from the ceiling or some other structure, such as with light hangers, from a ceiling or cross-bar structure, across the top over a grow table. Such would provide a more economical product, as it provides a cost savings in manufacturing costs and materials.

In those assemblies where a trellis is provided, the trellis support poles may be used to hang netting. Netting will be useful for supporting mature plants positioned inside the grow table. Two or more single tier grow tables may be bolted together to provide a longer length grow table, for example, a longer grow table of 36 feet in length by bolting together three individual grow tables that are 4 four foot wide by 12 foot long.

Two-Tier Grow Table and/or Grow Platform:

In another aspect, a grow table and/or grow platform is provided having 2 or more levels and/or platforms suitable for placing plants.

A first level (bottom-most level) platform for plant placement is provided, and comprising a stationary, lower level. (FIG. 12, #62). A second level (upper-most level/center (FIG. 12, #66) plant platform is provided to provide for placement of plants as well. A light source to provide light to the plants located on the first plant platform level, may comprise light sources (bulbs) integrated on a trellis structure or provided on hangers located on the underside (bottom side) of the second level plant platform. A light source for plants positioned on the second plant platform may be provided by lights suspended from a ceiling or pole traversing across the top of the grow table (FIG. 12, #67).

Assembly of Two or More 2-Tier Grow Tables and/or 2-Tier Grow Platforms—

The two-tier grow tables may be joined together to provide a row, or assembly, of two-tier grow tables. The grow tables may include a light source suitable for providing light to plants located on the bottom plant platform. The light source may be provided as pendant lights from the underside of the second level plant platform, or as lights incorporated onto a trellis. The trellis support poles of the assembly may include lights attached to a trellis frame, such as to enable multiple lights to be raised and lowered at once above the interior of the 2-tier grow table The trellis provides a structure suitable for moving all or some of the lights thereon up and down as part of the grow table, and may be powered by the touch of a switch button to activate a winch. The switch button may be provided as a pendant switch button for easier access by a user.

The two-tiered grow tables may be provided and built for commercial sale (built and sold) without a trellis frame. In this embodiments, the lights sources could be hung from the ceiling or some other structure, such as with light hangers, from a ceiling or cross-bar structure, across the top over the grow table. Such would provide a more economical product, as it provides a cost savings in manufacturing costs and materials.

In those assemblies where a trellis is provided, the trellis support poles may be used to hang netting. Netting will be useful for supporting mature plants positioned inside the grow table. Two or more two-tiered grow tables may be bolted together to provide a longer length grow table, for example, a longer grow table of 36 feet in length by bolting together three individual grow tables that are 4 four foot wide by 12 foot long.

Grow Facility and/or Grow Complex—Two or More Container Modules/Units:

In a general and overall sense, the present disclosure presents improved movable and/or mobile specially designed combinations of modular, container units as part of a grow facility and/or grow complex. In some embodiments, the grow facility comprises 2, 3, 4, 5, 6, 8, 10, or more specially designed individual modular container-based units that are inter-connected to each other, and that may also optionally be connected to a specially designed central corridor. FIG. 1 presents an example of a grow facility that comprises 8 specialty designed individual modular container-based units. Each of the modular container units are removably connected to each other, and are connected to a central corridor.

Mother Container—FIG. 2 presents another embodiment of a grow facility that comprises 8 specialty designed individual modular container-based units. In some embodiments, one of the specialty module containers is designed so as to be suitable as a “Mother/Vault/Potting” module container (FIG. 2, #502).

Flower Container Module—In other embodiments, 5 of the specialty module containers are designed so as to be suitable for “Flowering” of plants (“Flower” container room) (FIG. 2, #501), and will include two rows of movable, single-tier grow tables (FIG. 2, #505), the underside of the Flower container's tables having a plate onto which wheels (FIG. 11, #50)(such as a set of conventional wheels or specialty wheels having a groove suitable for rolling along a V track on the floor) are attached.

The single-tier grow tables will include a light source unit (such as light fixtures) incorporated onto a trellis structure, located at the top of the single-tier table (FIG. 11, #55). These light source units may also be provided as individually adjustable single pendant lighting. Light fixtures mounted onto a trellis (FIG. 11, #53) may be electrically controlled to lower or raise multiple light sources above the plants, by operation of a winch (FIG. 11, #54), via pushing an electronical button switch.

Vegetation Container Module—In one embodiment, one of the specially module containers is designed to be suitable for the vegetation of plants (“Veg” room) (FIG. 2, #504), and will include two rows of two-tier grow tables. As described herein, the second-tier platform provides an adjustable height table that is adjustable up or down. In this way, the differing height of plants and light requirements for plants positioned on the lower level of the 2-tier table, may be accommodated. The Vegetation Container module will include a steel bar onto which wheels will be fastened, and then attached to the bottom of the container module (as discussed above).

The 2-tier grow table will comprise two light sources, an upper light source unit and a lower light source unit. The lower light source units will comprise light fixtures incorporated onto the underside of the second tier platform, and will be easily and automatically raised and lowered by the touch of a button, by operation of a wench, which will adjust the second tier platform up or down (FIG. 24A, #148, #149). Plants may be situated on the upper surface of the adjustable second tier platform (FIG. 24A-B, #150), and a second light source for plants located on the second tier level being provided from adjustable pendant lights and/or lights incorporated on a trellis at the top of the two-tier grow table (FIG. 24B, #148, #149).

Trimming/Drying Container Module—In another embodiment, one or more of the specialty module containers may be designed to be suitable for the trimming and/or drying of plants once they have reached maturity (“Trimming/Drying” Container Module/Room) (FIG. 2, #503). These containers/modules/units are designed so as to provide for suspending the mature plant material from the ceiling by cables, to accommodate drying of the plant.

Mother/Clone/Potting/Vault Container Module—In another embodiment, one or more of the specialty module containers may be designed to be suitable for the storage and maintenance of a select mother plants, such as a mother plants of specialized cannabis species of interest. Plant clones, plant potting area, finished products storage, and a water supply system, will be included in this Container Module. A single tier grow table (and light system as described herein) for mother plants is provided, as well as slide out shelves for clones to be kept until they have grown to a maturity level capable of thriving in a “Vegetation” container module (described herein).

Among other advantageous features, the single-tier grow tables/units and two-tier grow tables/units are highly mobile, permit maximum ease of access to plants located on the tables at virtually any angle, and facilitate easier access by cultivators/plant care-takers to the plants. Unlike other devices/apparatus, the movement of the present tables within a container/module is not limited by the stationary nature of the table being bolted/mounted to the floor of a grow house or nursery. Instead, wheels are mounted to the bottom of a plate, that is then mounted to the bottom of each grow table. This arrangement permits the movement of the grow table up to the maximum width of a container unit. By way of example, the present grow tables may travel a distance of about 2½ feet, to traverse the full aisle width within a container module. Within a 40 foot length container/module/unit, conventional table units using other “rolling” mechanisms, permit only an 8 inch travel distance to either side of a center position (assuming a 48¼ inch wide table on a 32¼ inch stand fixed to the floor). Travel motion is limited to 8 inches in order to avoid tipping the table by overhanging weight.

In particular embodiments, the specialty grow table units within a specialty container/module provides a most useful movable feature to stably and reliably provide for movement of the grow table without risk of harm to the plants situated therein. The method utilized to render the grow tables easily movable advantageously provides a relatively unlimited movement ability across larger and broader distances in a modular grow unit than previously was available. This feature presents a significant improvement over prior tables having very limited rolling distance. The improved rolling distance of the apparatus that spans the entire width of an enclosed modular container, while securely maintaining the contents of the growing tables, such as multiple rows of juvenile plants, stably within the grow tables. Limitations associated with other grow tables include a limited rolling distance of a few inches.

The improved, enhanced movement and rolling distance mobility of the present grow tables provides the user with added advantages and flexibility of use in managing a grow room configuration for optimal plant cultivation, including added flexibility for placement of plants securely within one or more grow tables. In this manner, a user may relocate a grow table within a grow room, and optimize changing light/water/air and other environmental conditions within a container module to best suit a particular group/type of plant.

The enhanced range of mobility of the apparatus also is also especially advantageous for optimal cultivation of young plants, such as in a plant nursery, and accommodates the easy re-location of groups of plants in the module/container to foster maximal growth of juvenile plants to a desired and/or appropriate maturity level. This advanced feature, among others, is particularly advantageous for the efficient cultivation of specialty plants, such as varieties of Cannabis sativa.

Upon achieving growth to an appropriate/desired maturity level, the apparatus permits easy and convenient transfer of multiple plants to a secondary room/unit/storehouse, or specialty module/container/unit, for completion of growth to maturity. This may be accomplished by placing the plants in the “Veg” room (Vegetation room) described above. The plants generally reside in this “Veg” modular container until the plant is about 8 to about 10 weeks old.

Conventional plant nursery tables fail to provide for the range of mobility of the presently disclosed tables/grow units of the present disclosure. Among other reasons, and not meaning to be held to any particular mechanism of action or theory of operation, other apparatus having limited range of mobility provide a designed table base frame may be fastened to the floor.

In particular embodiments, the single-tier and two-tiered plant grow table structures of the container/module structures comprise a number of nuts, bolts, plumbing fittings, cable fittings frame and other small components, that may be easily used to assemble, disassemble and reassemble a grow table, or to assemble, disassemble or reassemble a container/module as needed by a user, with that skill held by those of ordinary skill in the art.

In some embodiments, a third, fourth or other level of grow table levels may be provided according to the details provided here concerning assembly/reassembly of the exemplary two-tiered grow table, without an undue amount of experimentation or error.

In another aspect, the individual modules/containers of a grow facility, such as the one described herein having eight individual modules/containers, may be attached securely to each other. A seal and flange system/method is used to provide attachment of the container modules to each other, and provide an air-tight and water tight seal, at low cost and simple fabrication, permitting the user to modify a container or redefine a configuration or two or more container modules, for a particular desired grow facility configuration, as may be needed by the user (FIG. 29, Wall Seal Mount; FIG. 30, Roof Seal Mount).

### DESCRIPTION OF THE SEVERAL VIEWS OF THE DRAWINGS

Embodiments of the present inventive concept are illustrated by way of example in which like reference numerals indicate similar elements.

FIG. 1—Perspective view schematic of overall grow facility/grow complex having eight modular container units. A retention pond is provided underneath the modular containers. Walkways, streets, driveways, and other access paths to and around each modular container and the grow complex as a whole, may be provided. Overall grow complex and/or grow facility—#400; Container—#401; Corridor—#402; Front door—#403; Retention pond—#405.

FIG. 2—Top view schematic of overall facility. Overall grow facility and/or grow complex—#500; Flower Room—#501; Mother/Clone/Potting Room—#502; Drying room—#503; Vegetation room—#504; Rows of Single-tier grow tables—#505; Rows of 2-Tier Grow tables—#506.

FIG. 3—Top plan view showing interior and the ceiling lighting. Overall facility #300; Mother/Clone/Potting room—#302; Flower Room—#303; Vegetation room—#304; Drying room—#305.

FIG. 4—Top plan view showing and grow table lighting. Overall facility—200; Mother/clone/potting room—#201; Flower room—#203; Economizer/wall air conditioner—#204; Pump-up waste—#205; Drying room—#206; Grommet expansion hub—#250; Dimming module—#251; GFCI receptacle over floor—#252.

FIG. 5—Grow table electrical lighting schematic. Grow control diagram—#1000; Maser Interface—#1008; Expansion hub—#1009; Dimming module—#1010; Violet-violet/fray 0-10 V control wiring to light fixture—@1011; Wiring harness—#1012; Rack mounted grow lights (fixtures)—#1012.

FIG. 6—Side elevation view of 40′ container. Container—#900; Side of Container #901.

FIG. 7—Rear end elevation view of a 40′ Container; #900; Open end of container that attaches to the corridor—#902; Corner casting—#905; Flange, #910.

FIG. 8—Front end elevation view of 40′ container; Container—#900; Economizer/wall air conditioner—#904; Door on end of container leading to the outdoors—#906.

FIG. 9—Section view taken along line 9-9 of rear end elevation view of 40′ container.

FIG. 10—Section view taken along line 10-10 of rear end elevation view of 40′ container; Container—#900; Open end of container that attaches to the corridor—#902; Corner casting—#905; Flange—#910.

FIG. 11—End view of single level (single-tier) grow table in 40′ container (flower room). Wheels—#50; Track—#51; Grow Table—#52; Light Trellis—#53; Winch—#54; Light—#55.

FIG. 12—End view of double level (two-tier) grow table in 40′ container (vegetable room). Wheels—#60; Track—#61; First grow table—#62; Second grow table—#63; Light on second moving/adjustable frow table—#65; Platform for plants on top of second grow table—#66; Light (fixture) on top of trellis—#67.

FIG. 13—Side elevation view of the 45′ corridor. Opening on side of Corridor Container where a second container may be attached—#70; Dorr (leading from corridor to container—#71; Corrugated side of container—#73;

FIG. 14—Rear end elevation view of the 45′ corridor. Corrugated side of corridor #73; Door at end of Corridor leading to the outside (not the front door to the facility)—#74; Large cargo doors—#75.

FIG. 15—Front end elevation view of the 45′ corridor. Corrugated side wall of corridor—#73; Open end of corridor that connects to smaller (20 foot) section) of Corridor—#76; Corner casting—#77.

FIG. 16—Section view taken along line 16-16 of the front end elevation view of the 45′ corridor. Corrugated side wall of corridor—#73; Open end of corridor (connects to a smaller (20 foot) section of corridor—#77; Corner casting—#77.

FIG. 17—Section view taken along line 17-17 of the front end elevation view of the 45′ corridor. Open end of corridor that connects to a smaller section (e.g., 20 feet) of the corridor—#76; Corner casting—#77.

FIG. 18—Section view taken along line 18-18 of the side elevation view of the 45′ corridor.

FIG. 19—Side elevation view of single tier grow table. See Table 1 for designated numbered components.

FIG. 20A—End elevation view of single tier grow table with lighting in lowered position. See Table 1 for designated numbered components (Lights—#80; Trellis—#81; Plant—#84).

FIG. 20B—End elevation view of single tier grow table with lighting in upper position. See Table 1 for designated numbered components (Lights—#80; Trellis—#81; Plant—#84).

FIG. 21—Top plan view of single tier grow table with trellis and light only. See Table 1 for designated numbered components (Lights—#80; Trellis—#81; Plant—#84).

FIG. 22—Top plan view of single tier grow table with trellis and lights omitted See Table 1 for designated numbered components (Lights—#80; Trellis—#81; Plant—#84).

FIG. 23—Side elevation view of two-tier grow table. See Table 2 for designated numbered components (Moving trellis—#148; Light (fixtures) on Trellis—#149; Platform/surface (for plant placement)—#150).

FIG. 24A—End elevation view of two tier grow table with plants of differing sizes, including winches. See Table 2 for designated numbered components (Moving trellis—#148; Light (fixtures) on Trellis—#149; Platform/surface (for plant placement)—#150; Plant—#84).

FIG. 24B—Opposite end elevation view of two tier grow table with plants of differing size. See Table 2 for designated numbered components (Moving trellis—#148; Light (fixtures) on Trellis—#149; Platform/surface (for plant placement)—#150; Plant—#84).

FIG. 25—Top plan view of two tier grow table with trellis and lights omitted. See Table 2 for designated numbered components (Moving trellis—#148; Light (fixtures) on Trellis—#149; Platform/surface (for plant placement)—#150; Plant—#84).

FIG. 26—Top plan view of two tier grow table with trellis and lights only. See Table 2 for designated numbered components (Moving trellis—#148; Light (fixtures) on Trellis—#149; Platform/surface (for plant placement)—#150; Plant—#84).

FIG. 27—Top plan view of top table of two tier grow table. See Table 2 for designated numbered components (Moving trellis—#148; Light (fixtures) on Trellis—#149; Platform/surface (for plant placement)—#150; Plant—#84).

FIG. 28—Top plan view of bottom table of two tier grow table. See Table 2 for designated numbered components (Moving trellis—#148; Light (fixtures) on Trellis—#149; Platform/surface (for plant placement)—#150; Plant—#84).

FIG. 29—Section view of wall seal. Wall seal—#600; Container—#601; Interior walls of container—#602; Seal—#602, #603; Angle piece (Flange)—#605.

FIG. 30—Section view of roof seal. Roof seal—#700; Container—#701; Seal—#702; Angle piece (Flange)—#703; Tube—#704; Angle support—#705.

FIG. 31—Enlarged section view of seal. Watertight factory applied silicone bellows—#801; Microsphere-modified acrylic-impregnated pre-compressed foam—#802; Field applied corner bead alongside of cos—#805.

FIG. 32—Universal 90 turndown view of seal. Watertight factory applied silicone bellows—#801; Microsphere-modified acrylic-impregnated pre-compressed foam—#802; Seismic Colorseal—#803.

FIG. 33—Enlarged detail view of wheel using a track. Wheel with groove—#807; V-track—#808.

FIG. 34—Enlarged detail view of wheel rolling directly on floor. Wheel, no groove—#809; Floor (flat, no track)—#810.

FIG. 35—Wheels for the Single-Tier Grow Table—The single-tiered table has a structure under the table to which the wheels are mounted. The table is thus raised to a comfortable working height. Wheels attach to a base, and then to the bottom of the grow table is shown. The grow table is attached over the base in a crosswise fashion (4′ direction).

FIG. 36—Wheels for the Double Tier Grow table—The two-tiered table has only a ½″ high bar that separates the bottom of the table from the top of the wheels.

### DETAILED DESCRIPTION OF THE INVENTION

The following detailed description references the accompanying drawings that illustrate various embodiments of the present inventive concept. The drawings and description are intended to describe aspects and embodiments of the present inventive concept in sufficient detail to enable those skilled in the art to practice the present inventive concept. Other components can be utilized and changes can be made without departing from the scope of the present inventive concept. The following description is, therefore, not to be taken in a limiting sense. The scope of the present inventive concept is defined only by the appended claims, along with the full scope of equivalents to which such claims are entitled.

The following examples present a description of various specific aspects of the intended invention, and are not presented to limit the intended invention in any way.

In the following description, for purposes of explanation, specific numbers, materials and configurations are set forth in order to provide a thorough understanding of the invention. It will be apparent, however, to one having ordinary skill in the art that the invention may be practiced without these specific details. In some instances, well-known features may be omitted or simplified so as not to obscure the present invention. Furthermore, reference in the specification to phrases such as “one embodiment” or “an embodiment” means that a particular feature, structure or characteristic described in connection with the embodiment is included in at least one embodiment of the invention. The appearances of phrases such as “in one embodiment” in various places in the specification are not necessarily all referring to the same embodiment.

### Definitions

The phraseology and terminology employed herein are for the purpose of description and should not be regarded as limiting. For example, the use of a singular term, such as, “a” is not intended as limiting of the number of items. Also, the use of relational terms such as, but not limited to, “top,” “bottom,” “left,” “right,” “upper,” “lower,” “down,” “up,” and “side,” are used in the description for clarity in specific reference to the figures and are not intended to limit the scope of the present inventive concept or the appended claims.

Further, as the present inventive concept is susceptible to embodiments of many different forms, it is intended that the present disclosure be considered as an example of the principles of the present inventive concept and not intended to limit the present inventive concept to the specific embodiments shown and described. Any one of the features of the present inventive concept may be used separately or in combination with any other feature. References to the terms “embodiment,” “embodiments,” and/or the like in the description mean that the feature and/or features being referred to are included in, at least, one aspect of the description. Separate references to the terms “embodiment,” “embodiments,” and/or the like in the description do not necessarily refer to the same embodiment and are also not mutually exclusive unless so stated and/or except as will be readily apparent to those skilled in the art from the description. For example, a feature, structure, process, step, action, or the like described in one embodiment may also be included in other embodiments, but is not necessarily included. Thus, the present inventive concept may include a variety of combinations and/or integrations of the embodiments described herein. Additionally, all aspects of the present disclosure, as described herein, are not essential for its practice. Likewise, other systems, methods, features, and advantages of the present inventive concept will be, or become, apparent to one with skill in the art upon examination of the figures and the description. It is intended that all such additional systems, methods, features, and advantages be included within this description, be within the scope of the present inventive concept, and be encompassed by the claims.

Any term of degree such as, but not limited to, the term “about” as used in the description and the appended claims, should be understood to include the recited values or a value that is three times greater or one third of the recited values. For example, about 3 cm includes all values from 1 mm to 9 cm. For example, terms of degree can refer to less than or equal to +5%, such as less than or equal to +2%, such as less than or equal to +1%, such as less than or equal to +0.5%, such as less than or equal to +0.2%, such as less than or equal to +0.1%, such as less than or equal to +0.05%.

The terms “comprising,” “including” and “having” are used interchangeably in this disclosure. The terms “comprising,” “including” and “having” mean to include, but not necessarily be limited to the things so described.

Lastly, the terms “or” and “and/or,” as used herein, are to be interpreted as inclusive or meaning any one or any combination. Therefore, “A, B or C” or “A, B and/or C” mean any of the following: “A,” “B” or “C”; “A and B”; “A and C”; “B and C”; “A, B and C.” An exception to this definition will occur only when a combination of elements, functions, steps or acts are in some way inherently mutually exclusive.

The term “platform” is employed to define a surface suitable for supporting, holding or containing one or more elements, such as one or more container units, plants, carrier units, trays, water supplying elements, light source, etc.

The term “solid support” as used herein refers to a material having a rigid or semi-rigid surface. Such materials will preferably take the form of small beads, pellets, disks, chips, or wafers, although other forms may be used.

The term “surface” as used herein refers to any generally two-dimensional structure on a solid substrate and may have steps, ridges, kinks, terraces, and the like without ceasing to be a surface.

It should also be understood that, unless clearly indicated to the contrary, in any methods claimed herein that include more than one step or act, the order of the steps or acts of the method is not necessarily limited to the order in which the steps or acts of the method are recited.

Having described several embodiments, it will be recognized by those skilled in the art that various modifications, alternative constructions, and equivalents may be used without departing from the spirit of the present inventive concept. Additionally, a number of well-known processes and elements have not been described in order to avoid unnecessarily obscuring the present inventive concept. Accordingly, this description should not be taken as limiting the scope of the present inventive concept.

Those skilled in the art will appreciate that the presently disclosed embodiments teach by way of example and not by limitation. Therefore, the matter contained in this description or shown in the accompanying drawings should be interpreted as illustrative and not in a limiting sense. The following claims are intended to cover all generic and specific features described herein, as well as all statements of the scope of the method and assemblies, which, as a matter of language, might be said to fall there between.

### EXAMPLES

The following examples are included to demonstrate preferred embodiments of the disclosure. It should be appreciated by those of skill in the art that the techniques disclosed in the examples that follow represent techniques discovered by the inventor to function well in the practice of the present disclosure, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the present disclosure.

### Example 1—Single-Tier Grow Table

The present example provides a detailed description of a table having a single level platform suitable for containing plants. The term used in description of this apparatus is a Single-Tier Grow table. A row of single tier grow tables may be provided by joining three table sections (or 4 table sections, if a 4′ by 48′ table assembly is preferred by a user) that are each approximately 4′ by 12′ each, to provide a table assembly having dimensions of 4′ by 36′. A row of two-tier grow tables may be constructed in the same manner by joining table sections having a dimensions of 4′ by 12′, as described herein.

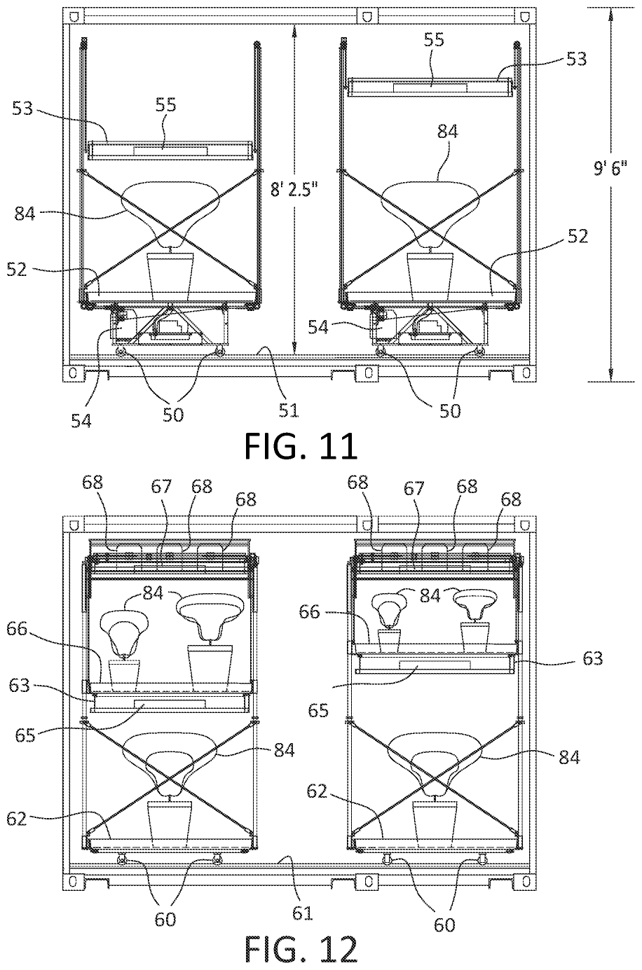

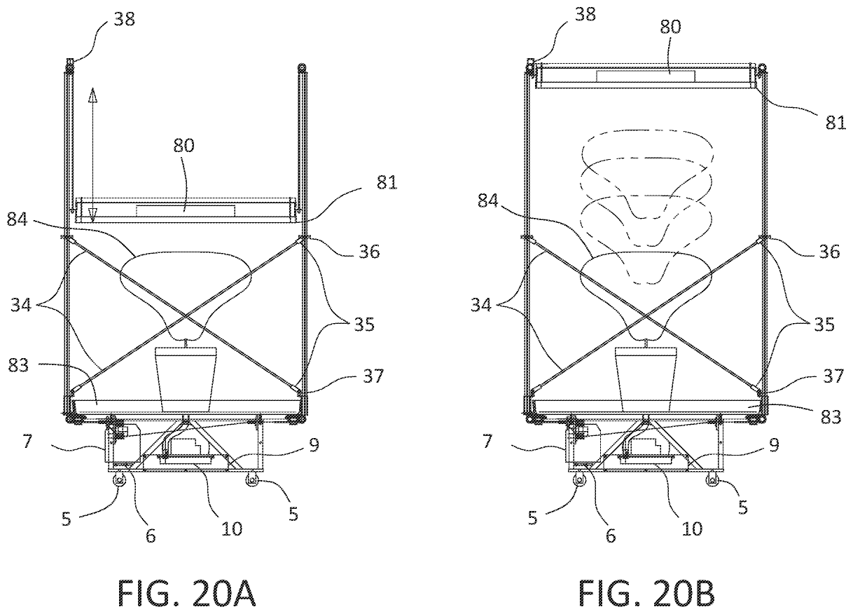

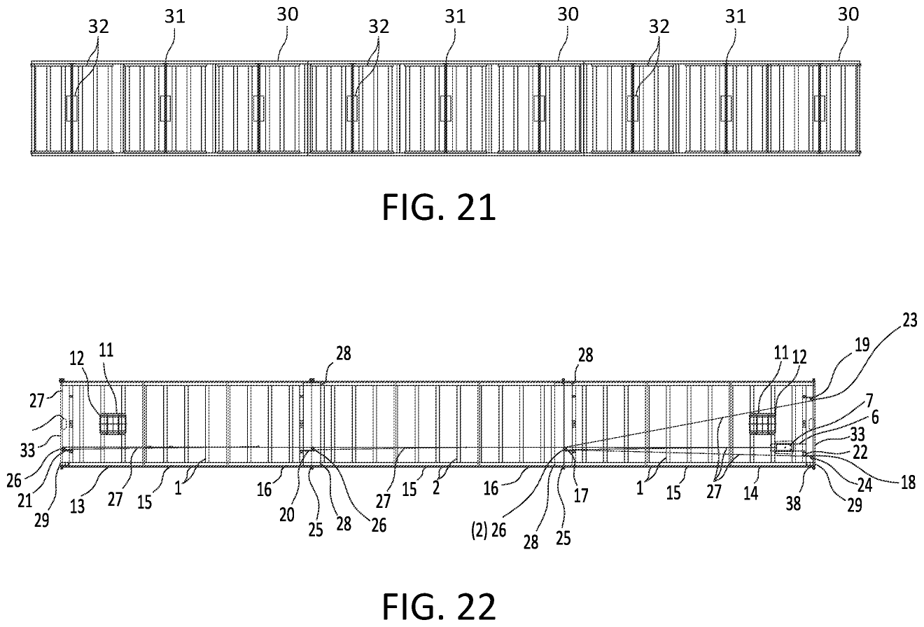

FIGS. 11, 19, 20A-20B, 21 and 35 are provided to illustrate various aspects and components of the Single-Tier Grow Table.

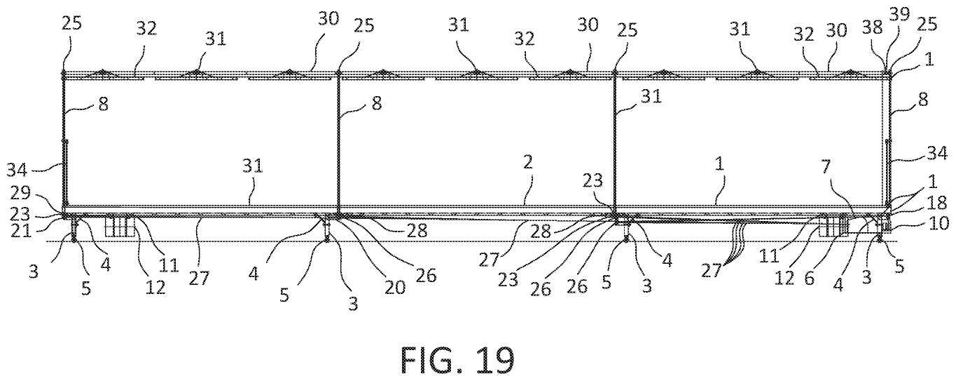

The various component parts of the single-tier grow table referenced by numerical designation throughout the FIGS. 19, 20A-20B and 21, are provided Table 1:

TABLE 1
COMPONENTS FOR SINGLE TIER TABLE
(PER SINGLE TIER, 3-SECTION, TABLE ASSEMBLY)

| | | | | |
|---|---|---|---|---|
| ITEM | | | | |
| NUMBER | QUANTITY | DESCRIPTION | MODEL | MANUFACTURER |

| | | | |
|---|---|---|---|
| 1 | 2 | TABLE, END | SHORELINE POWER SERVICES |
| 2 | 1 | TABLE, CENTER | SHORELINE POWER SERVICES |
| 3 | 4 | TABLE, SUPPORT-SINGLE TIER | SHORELINE POWER SERVICES |
| 4 | 8 | TABLE, BRACE-SINGLE TIER | SHORELINE POWER SERVICES |
| 5 | 8 | 3″ V-GROOVE WHEEL | |
| 6 | 1 | WINCH SUPPORT | SHORELINE POWER SERVICES |
| 7 | 1 | WINCH | |
| 8 | 8 | TRELLIS SUPPORT-SINGLE TIER | SHORELINE POWER SERVICES |
| 9 | 1 | PUMP BRACKET-SINGLE TIER | SHORELINE POWER SERVICES |
| 10 | 1 | WASTE PUMP | |
| 11 | 4 | FAN MOUNTING BRACKET | SHORELINE POWER SERVICES |
| 12 | 2 | 10″ INLINE FAN | |
| 13 | 1 | TRAY 4 × 4+ | |
| 14 | 1 | TRAY 4 × 4− | |
| 15 | 3 | TRAY 4 × 4 CENTER | |
| 16 | 2 | TRAY 8 × 4 CENTER | |
| 17 | 1 | SHEAVE BRACKET NO 1 | SHORELINE POWER SERVICES |
| 18 | 1 | SHEAVE BRACKET NO 2L | SHORELINE POWER SERVICES |
| 19 | 1 | SHEAVE BRACKET 2R | SHORELINE POWER SERVICES |
| 20 | 1 | SHEAVE BRACKET NO 3 | SHORELINE POWER SERVICES |
| 21 | 1 | SHEAVE BRACKET NO 4 | SHORELINE POWER SERVICES |
| 22 | 1 | SHEAVE BRACKET SHIM | SHORELINE POWER SERVICES |
| 23 | 9 | 1.5″ Flat Mount Block | |
| 24 | 1 | 1.5″ Flat Mount Block-SN | |
| 25 | 8 | 1.5″ Flat Mount Block-2 | |
| 26 | 4 | 1.5″ Flat Mount Block-2-SN | |
| 27 | N/A | PRO Strand 3/16″ × 500′, 7 × 19, Galvanized Cable | |
| 28 | 4 | JUNCTURE TUBE | SHORELINE POWER SERVICES |
| 29 | 4 | SHEAVE END TUBE | SHORELINE POWER SERVICES |
| 30 | 3 | LIGHT TRELLIS | SHORELINE POWER SERVICES |
| 31 | 9 | LIGHT HANGER BAR | SHORELINE POWER SERVICES |
| 32 | 9 | SPYDR 2i LED Panel | |
| 33 | 1 | HEADER SUPPORT | SHORELINE POWER SERVICES |
| 34 | | 18-8 stainless steel threaded rod, ⅜′ - 16 × 5 | |
| 35 | | Socket eye nut | |
| 36 | | Treaded rod mount clamping hangers | |
| 37 | | Angle Bracket | |
| 38 | | Limit Switch | |
| 39 | | Switch bracket | |
| 80 | | Lights/light fixtures | |
| 81 | | Trellis | |
| 83 | | Platform | |
| 84 | | Plant | |

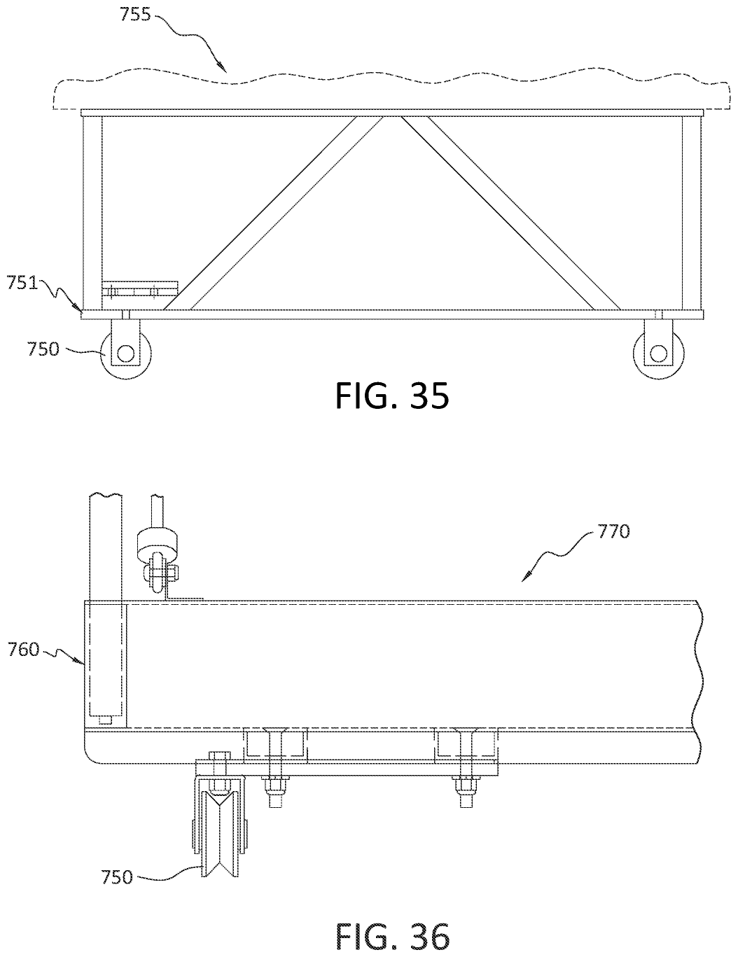

The wheels provided as a component of the single-tier grow tables is provided by as depicted in FIG. 35. The wheels are provided onto a base structure, so as to separate the bottom of the grow table from the wheels by about 10 inches. This serves to raise the level of a single-tier grow table situated thereupon to a height more comfortable for use/access by a user. For example, the base structure may be about 10 inches high, thus separating the wheels from the bottom of the grow table a sufficient distance to run cables, wiring, irrigation pipes, waste lines, etc. underneath of the table. The base structure (with the wheels attached to the bottom side thereof) will then be mounted on the bottom of a single tier grow table. The single tier grow table will preferably be secured to the top of the base in a cross-wise direction, relative to the wheel/base structure (4′ direction).

### Example 2—Two-Tier Grow Table

The present example provides a detailed description of a table having a two-tiered structure providing two platform areas suitable for containing plants. The term used in description of this apparatus is a Two-Tier Grow table.

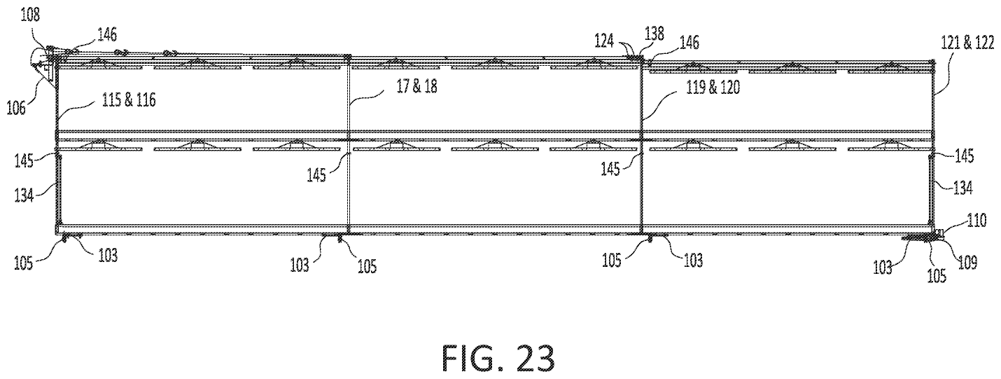

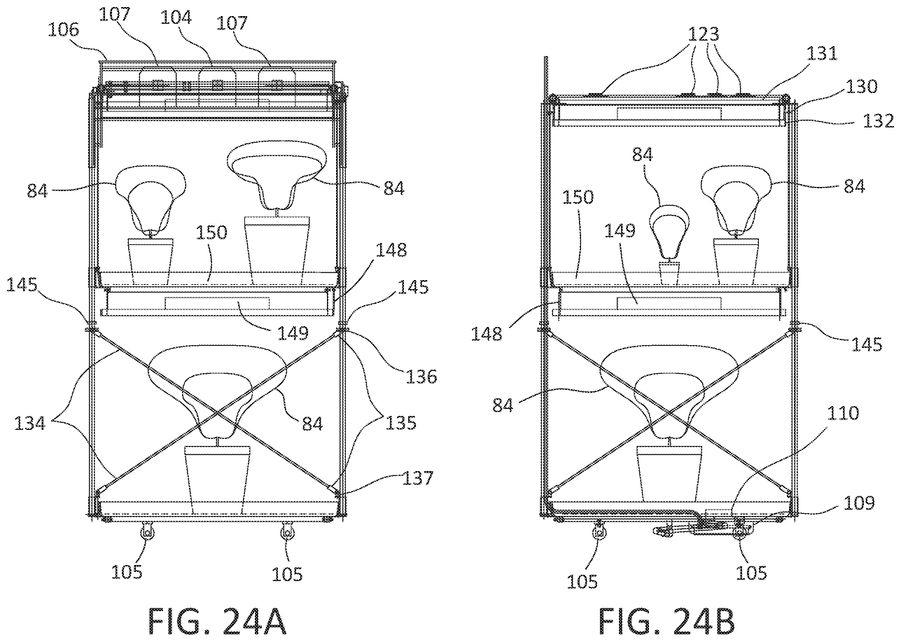

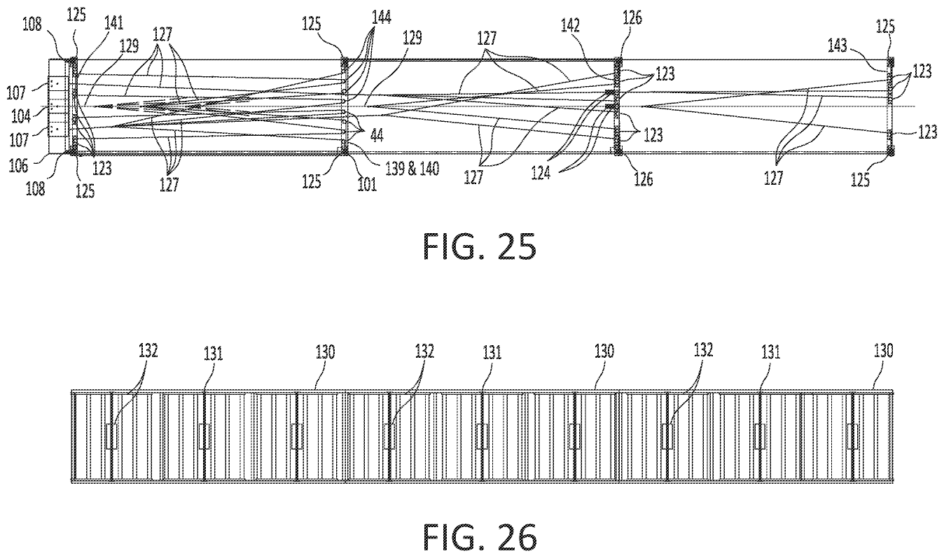

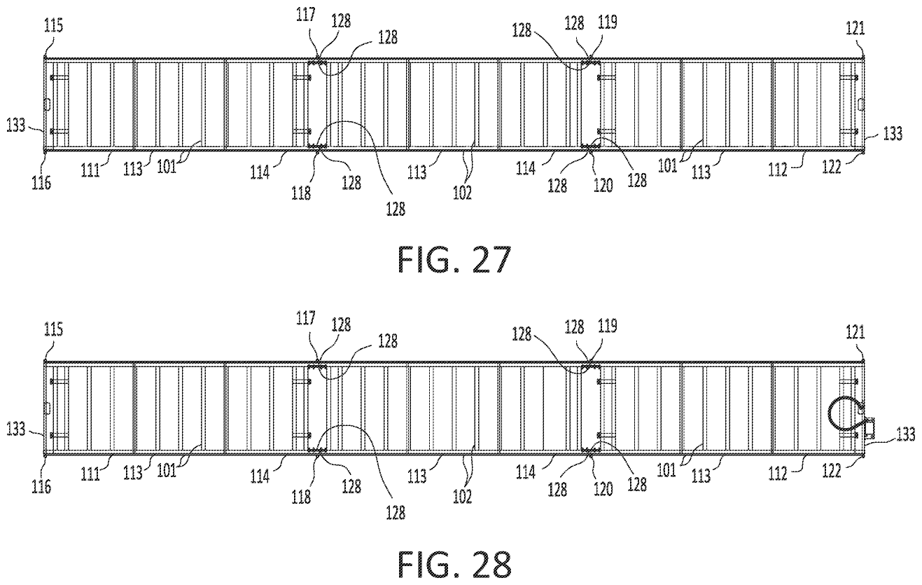

The various component parts of the two-tier grow table referenced by numerical designation throughout FIGS. 12, 23-28 and 36 are provided in Table 2.

COMPONENTS FOR DOUBLE TIER TABLE
(PER TWO-TIER, 3-SECTION, TABLE ASSEMBLY)

| ITEM | | | | |
|---|---|---|---|---|
| NUMBER | QUANTITY | DESCRIPTION | MODEL | MANUFACTURER |
| 101 | 2 | TABLE, END | | SHORELINE POWER SERVICES |
| 102 | 1 | TABLE, CENTER | | SHORELINE POWER SERVICES |
| 103 | 6 | WHEEL BAR | | SHORELINE POWER SERVICES |
| 104 | 1 | WINCH | | |
| 105 | 6 | 3″ V-GROOVE WHEEL | | |
| 106 | 1 | WINCH FRAME | | SHORELINE POWER SERVICES |
| 107 | 2 | WINCH | | |
| 108 | 2 | COMPRESSION ADJUSTER | | |
| 109 | 1 | PUMP BRACKET DOUBLE TIER | | SHORELINE POWER SERVICES |
| 110 | 1 | WASTE PUMP | VCCA-20ULS | |
| 111 | 2 | TRAY 4 × 4+ | Infinity Tray, 4′ × 4′ Endcap (+) | |
| 112 | 2 | TRAY 4 × 4− | Infinity Tray, 4′ × 4′ Endcap (−) | |
| 113 | 6 | TRAY 4 × 4 CENTER | Infinity Tray, 4′ × 4′ Center | |
| 114 | 4 | TRAY 8 × 4 CENTER | Infinity Tray, 8′ × 4′ Center | |
| 115 | 1 | TRELLIS SUPPORT, VEG-A | | SHORELINE POWER SERVICES |
| 116 | 1 | TRELLIS SUPPORT, VEG-A′ | | SHORELINE POWER SERVICES |
| 117 | 1 | TRELLIS SUPPORT, VEG-B | | SHORELINE POWER SERVICES |
| 118 | 1 | TRELLIS SUPPORT, VEG-B′ | | SHORELINE POWER SERVICES |
| 119 | 1 | TRELLIS SUPPORT, VEG-C | | SHORELINE POWER SERVICES |
| 120 | 1 | TRELLIS SUPPORT, VEG-C′ | | SHORELINE POWER SERVICES |
| 121 | 1 | TRELLIS SUPPORT, VEG-AS′ | | SHORELINE POWER SERVICES |
| 122 | 1 | TRELLIS SUPPORT, VEG-AS | | SHORELINE POWER SERVICES |
| 123 | 16 | 2″ Deck Pully Block Single Sheave | D00208 - 2″ | |
| 124 | 4 | 1.5″ Flat Mount Block-SN | 01558-SN | |
| 125 | 6 | 1.5″ Flat Mount Block-2 | 01558-2 | |
| 126 | 2 | 1.5″ Flat Mount Block-3 | 01558-2-SN | |
| 127 | N/A | PRO Strand 3/16″ × 500′, 7 × 19, | 21015050 | |
| | | Galvanized Cable | | |
| 128 | 6 | JUNCTURE BAR | | SHORELINE POWER SERVICES |
| 129 | 1 | PRO Strand ¼″ × 250′, 7 × 19, | 21020025 | |
| | | Galvanized Cable | | |
| 130 | 3 | LIGHT TRELLIS | | SHORELINE POWER SERVICES |
| 131 | 9 | LIGHT HANGER BAR | | SHORELINE POWER SERVICES |
| 132 | 9 | SPYDR 2i LED Panel | FLUENCE-SR-2I-I-1 | |
| 133 | 4 | HEADER SUPPORT | | SHORELINE POWER SERVICES |
| 134 | 2 | 18-8 STAINLESS STEEL TREADED ROD, | P.N. 98847A264 | |
| | | ⅜″-16 × 5′ | | |
| 135 | 2 | SOCKET EYE NUT | P.N. 29995T71 | |
| 136 | 2 | THREADED-ROD-MOUNT CLAMPING | P.N. 8028N21 | |
| | | HANGERS | | |
| 137 | 2 | ANGLE BRACKET | Stainless Steel 30 mm × 30 mm | |
| 138 | 1 | SHEAVE OFFSET MOUNT | | SHORELINE POWER SERVICES |
| 139 | 1 | SHEAVE X-BAR 1T | | SHORELINE POWER SERVICES |
| 140 | 1 | SHEAVE X-BAR 1B | | SHORELINE POWER SERVICES |
| 141 | 1 | SHEAVE X-BAR 2 | | SHORELINE POWER SERVICES |
| 142 | 1 | SHEAVE X-BAR 3 | | SHORELINE POWER SERVICES |
| 143 | 1 | SHEAVE X-BAR 4 | | SHORELINE POWER SERVICES |
| 144 | 6 | 2″ Sheave with Bronze Bushing | HB130102 | |
| 145 | 6 | Clamping Collar | CLC2-16 | |
| 146 | 2 | LIMIT SWITCH | 12T968 | |
| 148 | | Moving Trellis | | |
| 149 | | Light fixtures on moving trellis | | |
| 150 | | Second Platform surface above trellis | | |
| 84 | | plant | | |

The two-tiered tables are equipped with light sources that provide for light for plants situated on both the bottom level of the table and the upper level of the table. The light source suitable for providing light to plants on the second level of the table may either be hung on a trellis, and therefore may be moved up and down over the plants on the lower level of the table. The adjustment of the lights may be provided by manual manipulation, or by operation of a winch. With a winch control mechanism, a momentary contact rocker switch is used, through operation of a winch control pendant accessible to the user.

The two-tier grow table is provided in the specialty canister/module described as the Vegetation (“Veg”) room/container module. As a component of the Vegetation room, FIG. 2, #504, depicts the two rows of two-tier growing tables as #506.

The two-tier grow tables have a lower level table and an upper second level table (See FIGS. 12A and 12B). Plants may be placed on both levels of the table. The underside (bottom side) of the upper second level table may include a built in light and trellis system, with attached (integrated) lights, these lights serving to shine down on the plants that are on the lower first level of the two-tier table. The trellis support poles of the 2-tier table guide the second level table and the light trellis frame, both of which may be raised and lowered independently.

Lights on the underside of the upper table can be automatically adjusted by the push of a button. A wench then operates to move the lights all at once (or as a section, see below description), up or down. to an optimal distance from the plants foliage. (Not just adjust individual lights up and down, not adjustment by manual means).

A “pendant” style structure hanging down is a “button” type controller. The user simply presses this button to make the upper level table go up or down. The top of the two-tier grow table also has lights integrated onto a trellis. This trellis may be divided into two sections each of which are independently controlled to move the respective section's lights, up or down. A pendant housed switch operates a winch for each trellis section.

An added advantage of the two-tier table is that the upper table can be in a lower position for easier access to upper tiered plants for trimming, etc, by a user. Lights on the light trellises located on the underside of the second level (shelf) of the two-tier grow table, raise/lower independently of the upper level light trellis(s) height position(s).

The light trellis can be divided into two sections that move independently, allowing two different heights of lights above the plants on the second level of the two tiered table, as a design option. This option is shown in the two-tier table design illustrations herein). This allows for lights to be positioned at a level that is most optimal for a plants having a taller foliage height, together with plants having a shorter foliage height of different ages and heights, having lights lower to accommodate the plant height on the second level table.

The feature of divided upper light trellis permits the user to adjust the lighting to be higher for plants on the longer table section, and to adjust the shorter section to be suitable for shorter plants. The two tiered table includes this added feature and is the reason for the third winch. There are 2 winches controlling the upper light trellises on the two-tier table. One winch serves to move the longer light trellis (24 ft. long, nearest the winch end of the table). The other wench is used to adjust the length of the shorter light trellis (12 ft long light trellis) on the opposite end.

The wheels provided as a component of the two-tiered grow table are shown in FIG. 36. In this embodiment, the wheels will be mounted to a rectangular bar (FIG. 36, #760), such as a rectangular bar having a height of about 1%2 inch, so as to separate the bottom of the table from the top of the wheels.

The interior depth of a grow table is 4″. This depth serves to protect the trays having a shorter length than 4″ from damage.

### Example 3—Adjustable Multiple Light Integrated Trellis System

The present example presents one embodiment of the adjustable multi-light integrated trellis system. The integrated light trellis system may be provided in a single-tier grow table or on a two-tier grow table, and may be configured to raise or lower lights over a group of plants electrically through operation of a button activated wench system.

### Example 4—Modular Container Facility/Grow Complex-Growth, Vegetation, Processing Modular Containers and Assemblies Thereof

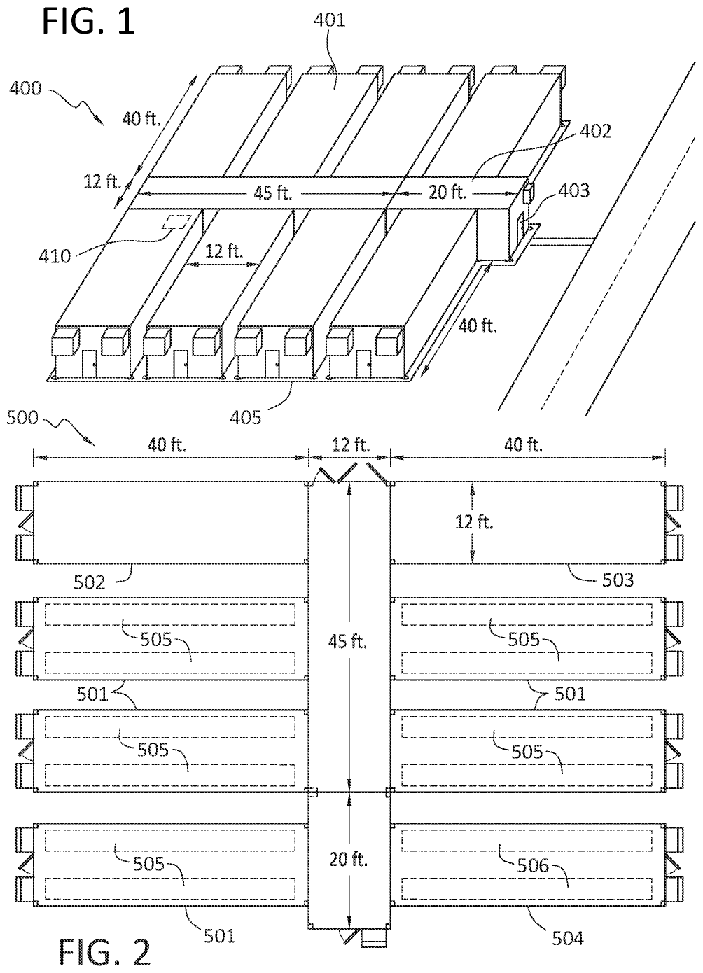

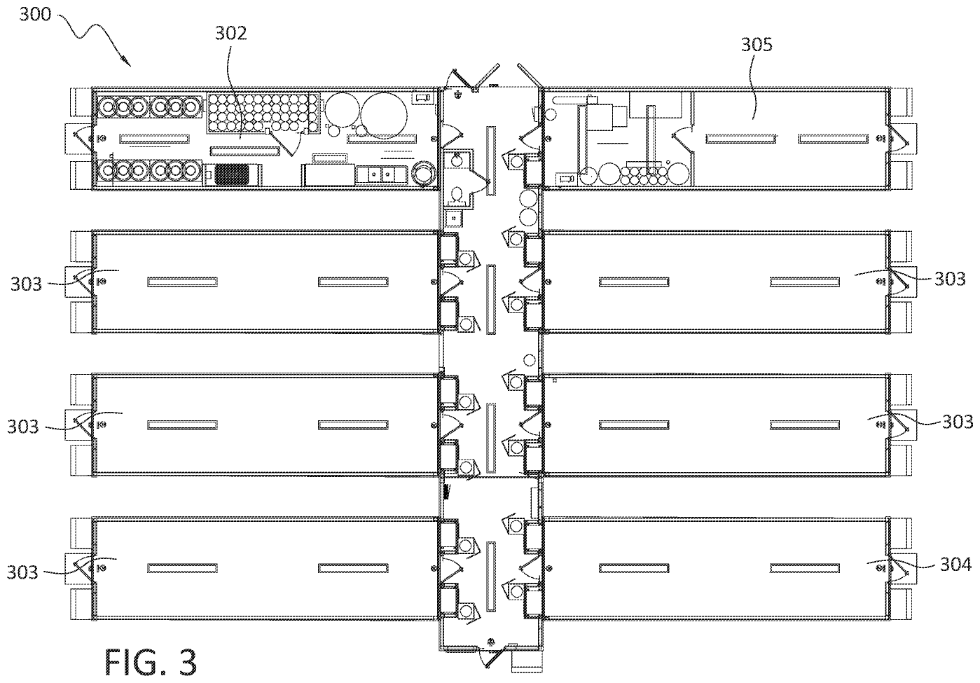

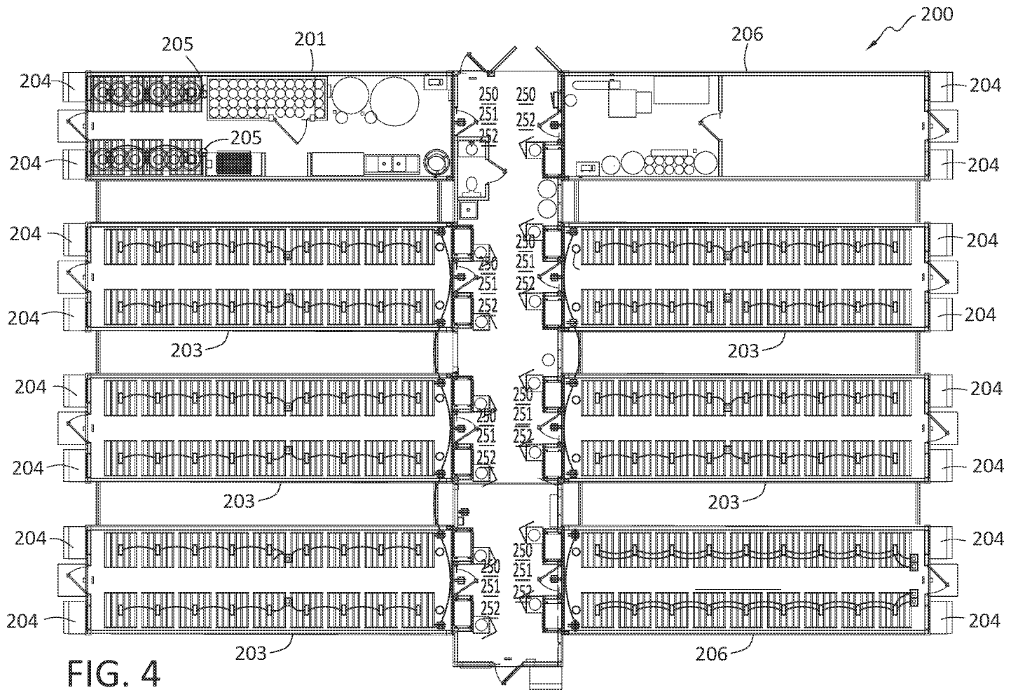

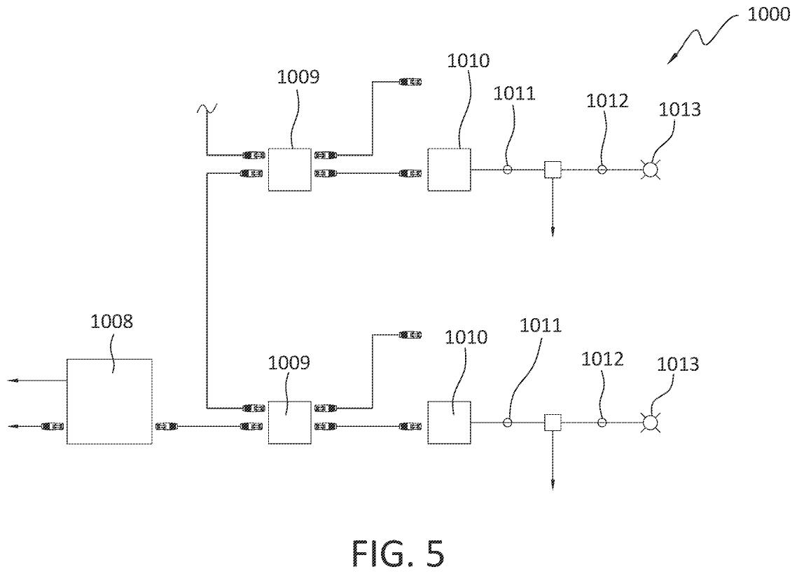

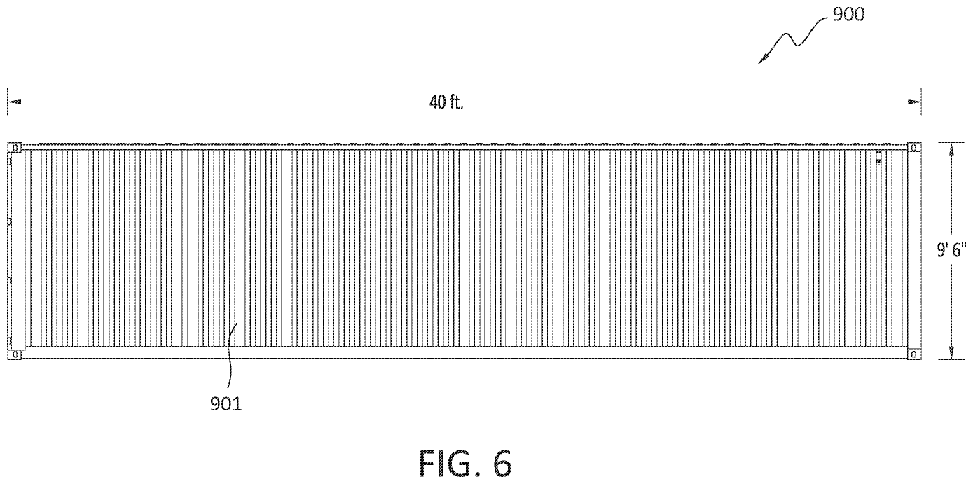

The present example presents an example of a complete grow and processing facility for plants, such as cannabis, comprised of several modular container units connected to each other. This individual specialty modified modular containers (such as modified shipping containers) are prepared from containers having a total height of 9′ 6″, with an interior container height of about 8′ 2½ ″. Containers having a length of 20 feet, 40 feet, 48 feet, 53 feet, or other available length commercial container, may be used in the creation of the specially modified modular containers. Figures depicting a Grow Facility comprised of the modified modular container unites are provided at FIGS. 1, 2, 3, and 4. In some embodiments, two or more modular containers may be connected to each by cutting out the side of each container, and connecting the open sides of each container together with each other. For example, two 8 foot wide containers may be connected by cutting the length side out of each of the two containers, and then connecting the open sides of each of the two containers together, to provide a wider single container. In this example, and providing for some space for engineering, a resulting, joined two container structure will have a width of about 12 feet (allowing for about 4 feet of “working space” in the engineering process used for connecting the two containers along their respective lengths).

Vegetation Container Module—As used in the figure depictions and legends, the term “Veg” is used to mean “vegetation” grow room. In some embodiments, this room is the only room within a facility unit that will include two tier grow tables. A typical cannabis plant will spend about the first 8 to about 10 weeks in this room (approximately, varies with strain of plant).

Flower Container Module—As used in the figure descriptions and legends, the term “flower” depicts a flowering plant grow room. The flowering grow rooms will in some embodiments, include primarily the single-tier grow tables. A typical cannabis plant will spend about their last 10 weeks in a flowering rooms (approximately, varies with strain of plant). Typical cannabis plants are usually much larger by this time of growth, on average. Therefore, more space must be permitted within a single assembly of the grow tables to best accommodate the plant size and/or height. Therefore, as a part of a commercial Grow Facility, a greater number of Flower Container modules are needed. In the diagram presented at FIG. 2, the Grow Facility comprises 5 flower container modules/flowering grow rooms (#501). Each flower container module includes two rows of single tier grow tables (#505), one “Mother/Clone” room (#502), one “Veg” (vegetation) room (#504) having two rows of two-tier grow tables (#506), and one “Drying” room (#503).

In some embodiments, a single row of the single tier grow tables that make up each of the two rows of grow tables in the “Flower” rooms may be described as having a size of 4 feet by 12 feet. Therefore, by way of example, a 40 foot length container configured as a “Flower” Room, will include two rows of tables, each row having a length of 36 feet. Roughly 3 of the single unit, single-tier grow tables may be placed end to end to provide one of these rows. A pump will be located to extend about 5½ ′ at the bottom of the table, providing a total length of the table and the pump of 36 feet, 5½ inches.

In some embodiments, a Grow Facility is provided comprising 2, 4, 6, 8, 10, 16, or more modular containers, each modular container and group of modular containers being configured for a particular use (Flower, Vegetation, Mother/Cloning, Drying), that is tailored to the grow needs, production goals, and design preferences of a user. A typical grow facility will comprise 8 modular container rooms as defined in FIG. 2.

Custom Length Grow Tables—A single-tier grow table for a “Flower” room, or a two-tier grow table for a “Vegetation” room, may be fabricated to a length tailored to the needs and requirements of a user. A grow table of any specified length may be created by the assembly of 2 or more grow tables together. The term “assembly” as used in the present description, relates to the joining of two or more grow tables by bolting the tables together with a junction bar (Table 2, #28). For example, a 36 foot grow table is provided by assembling/joining three 4 four wide by 12 foot long grow tables, by bolting them together with a juncture bar (Table 2, #28). Should the user prefer a longer grow table, for example a 48 foot grow table, four of the 4 foot×12 foot table sections may be bolted together to provide a 48 foot grow table.

In some embodiments, each row of two-tier grow tables (FIG. 2, #506) in a “Veg” room (FIG. 2, #504), will include a wench hanging past the end at the top of the table, and the length of the two-tier table will measure 37′-1″.

A retention pond (FIG. 1, #405), with or without pipes/tubes/drainage systems (FIG. 1, #410) may also be provided as part of a modular container grow facility/grow complex. For example, a retention pond and/or retention area may be provided to leach water into the ground that has run off of the roofs, sidewalks and driveways. The retention pond/area may be an about 8 to 16″ deep area that has been excavated and filled with washed stone, and will serve to retain water. This depth of a retention pond appropriate for a particular grow facility/grow complex will be calculated based on the permeability of the soil at the site, and the size of the hard surface areas.

In some embodiments, the retention pond will be located under the modular container (401 & 402). The retention pond may extend about 12 ft. beyond the outer perimeter of modular containers. Therefore, and in one exemplary embodiment, the retention pool may measure approximately 66 ft×93′. Cylindrical concrete pilings (for example, having a diameter of about 36″) are provided under each corner of a modular container. Alternatively, where there are multiple container modules close together (such as in a grow facility/grow complex as described herein), and multiple modular container corners are close together, a single (such as a rectangular) foundation may be provided under the several modular containers. A retention pond would be placed such as to surround the concrete pilings and/or foundation. An illustration of the arrangement of a retention pond relative to concrete pilings and/or a concrete foundation is provided in FIG. 1. FIG. 1 also depicts a basement as a component of the grow facility/grow complex. The basement provides access and an area for connecting waste lines from the grow complex/grow facility to the sewer, and also permits water entry to the complex/facility and to the modular containers. Access to the basement may be provided through a trap door, such as a trap door placed in the floor of the corridor.

The maneuverability of the two rows of single-tier and two-tier grow tables in a modular container room is facilitated by the placement of wheels attached to a steel plate on the bottom of each grow table. The wheels permits the user to maneuver the grow tables easily across the entire width ((11 feet) of the inside of a modular container. The grow tables are not mounted permanently to the inside flooring of a modular container room. Each modular container room is securely, but detachably, mounted to pilings (concrete foundation) at a desired location.

### Example 5—Room Equipment Detail

The present example provides a summary of the components of each of the containers/rooms provided as a component of a complete facility grow complex, or as a stand-alone container/compartment unit for use in an alternative configuration than that provided here, according to the needs of a particular user or group of users.

### Vegetation Room and Flower Modular Container/Compartment Rooms:

A Grow Complex in one example, will include 1 “Veg” (vegetation) Container/Compartment (two rows of two-tiered grow tables) and 5 “Flower” Container/Compartments (two rows of single tier grow tables).

The “Veg” room will typically be used to house young plants, from the time the plant is at a new clone (approx. 2 wks.) stage until the plant has reached an age/size requiring more light and a greater height clearance. This typically occurs at a plant age of about 8 to about 10 weeks.

The following systems will be a component of each “VEG” Modular Container/Compartment and each “Flower” Modular Container/Compartment:

Automatic Systems:
Air conditioners with electric heat; (2) 3.5 ton units with 6 kW heat
Dehumidifiers; (2) 320 pints/day
Carbon air cleaner; (2) 1260 cfm with 12″ fans
CO2 Enrichment with alarm and emergency off.
Fertigation with filtration and drip irrigation.
Condensate collection.
Waste fertigation collection.
Grow lighting.
Fans for air movement (flower rooms).

### Mother Plants, Clones, Vault, Potting Module Container:

The Mother/Clone/Potting module container will be equipped for keeping plant “mothers” of selected plants, root clones, pot plants, store finished products, and house water supply system. Fixed single tiered tables for mothers and Slide-out shelves for clones, will be included in this container module.

Automatic Systems:
Air conditioners with electric heat; (2) 2.5 ton units with 6 kW heat
Humidifier; (1) 16 gal/day
Fertigation with filtration and drip irrigation for mothers only.
Condensate collection.
Waste fertigation collection.
Grow lighting for mothers and clones with fixed or manually adjustable heights.
Reverse Osmosis water system with storage and delivery to mixing area (trimming/drying room).
Split AC for vault.

Other Equipment:
Commercial style kitchen sink.
Water heater.

### Drying, Trimming and Mixing Rooms:

The drying, trimming and mixing modular container room is designed to serve a dual purpose. It will be used to dry harvested crop and trim plant material/plants into sellable product forms. The room will also be the location for formulation, storage and distribution of fertigation materials.

Automatic Systems:
Air conditioners with electric heat; (2) 2.5 ton units with 6 kW heat
Dehumidifiers; (1) 320 pints/day & (1) portable 130 pints/day
Carbon air cleaner; (2) 1260 cfm with 12″ fans
Fertigation Mixing System with storage tanks and pumping systems.
Condensate collection.

Other Equipment:
Fans for air movement (4) ceiling style in drying room.
Plant drying racks
Fertilizer dispensing shelf (optional)
Trimming and bucking machines. (optional)

### Central Corridor:

A central corridor in the grow facility will serve as the main aisle for accessing all of the container modules of the grow complex/grow facility, as well as for housing some of the container module rooms' equipment described above. The central corridor will also hold piping and wireways for systems connections of the container module rooms.

Automatic Systems:
Air conditioner with electric heat; (1) 3.5 ton unit with 6 kW heat.
Condensate collection.
Building control system
   Controls all the environmental parameters of the equipment listed for each room.
   Controls the fertilization schedule.
Building access and security panel
Electrical Systems

Other Equipment:
Carbon air cleaner; (2) 1260 cfm with 12″ fans.
Mop sink
Half bathroom
Basement access

### Example 6—Flange-Seal System-Connectors for Joining Modular Container Units

The present example provides a description of the unique flange and seal construction used to join two or more modular container units together, in a secure and easily detachable and re-attachable configuration.

In one embodiment, a configuration of modular container units may be joined together using a unique and secure flange and seal methodology. This system/method is distinct from other attachment methods that place containers side-by-side and weld them together. The present systems and methods of seals and flanges are used to join two or more modular containers in a manner that is also to be separated for moving within a facility or to a secondary facility.

Process/Method for Connecting Modular Containers: The modular containers are placed a couple inches apart with wide flanges (3″ or 4″) facing each other (2″ space between flanges/containers). The position of the modular containers shall accommodate the alignment of a room (like a “Veg” or Flower room, as described herein) so as to connect with a central corridor of a grow facility. The modular container is open on the end facing the central corridor. The flanges will be located around the rectangular opening of the modular container (about 12′ wide×9′ high) and around the central corridor access point.

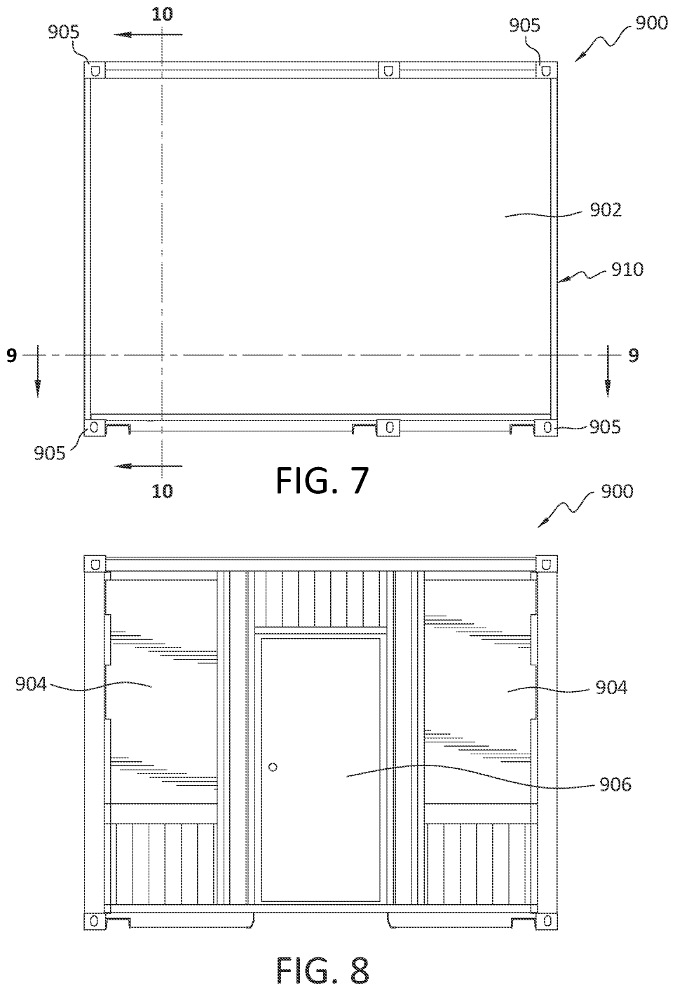

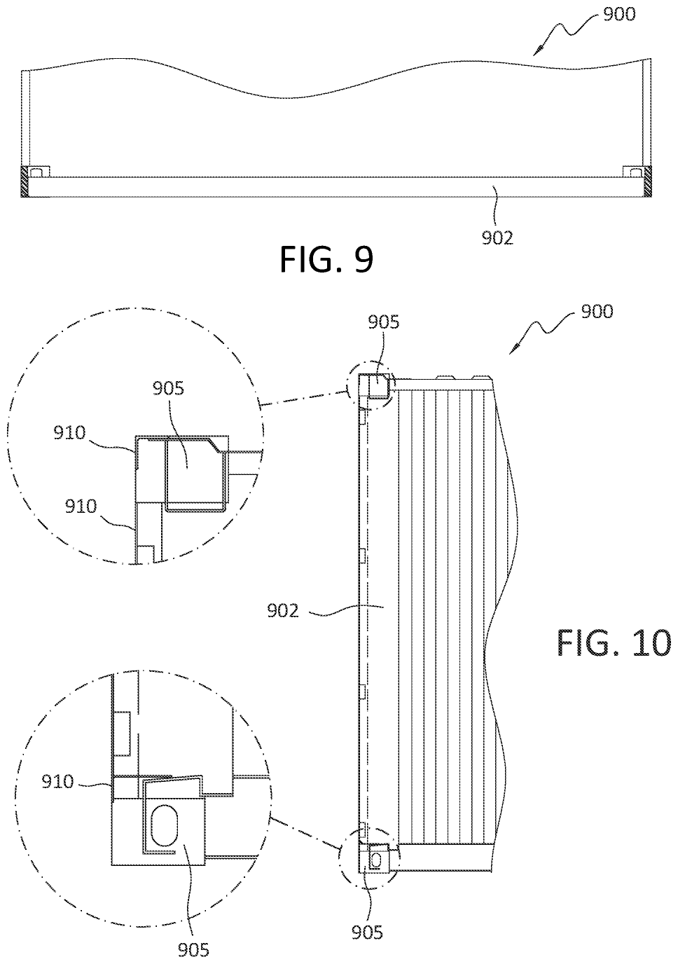

FIG. 7, shows the open end (FIG. 7, #902) of the 40′ grow room. The flanges (an angle iron piece) are shown (FIG. 10, #910), and the flange may have a width of about 2″ in some embodiments. However, the flange may vary in size, to be larger or smaller, for example, to use a flange of having a width of 3″ or 4″.

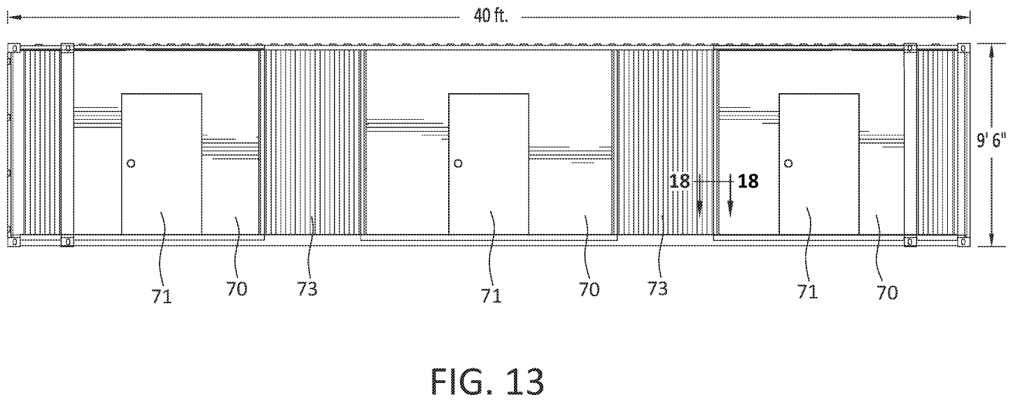

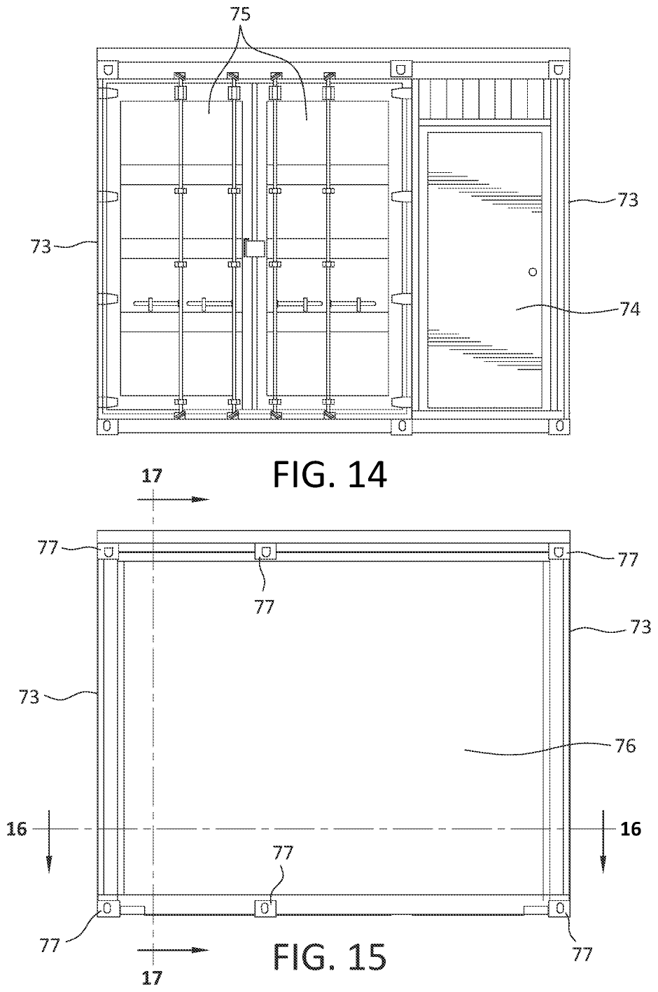

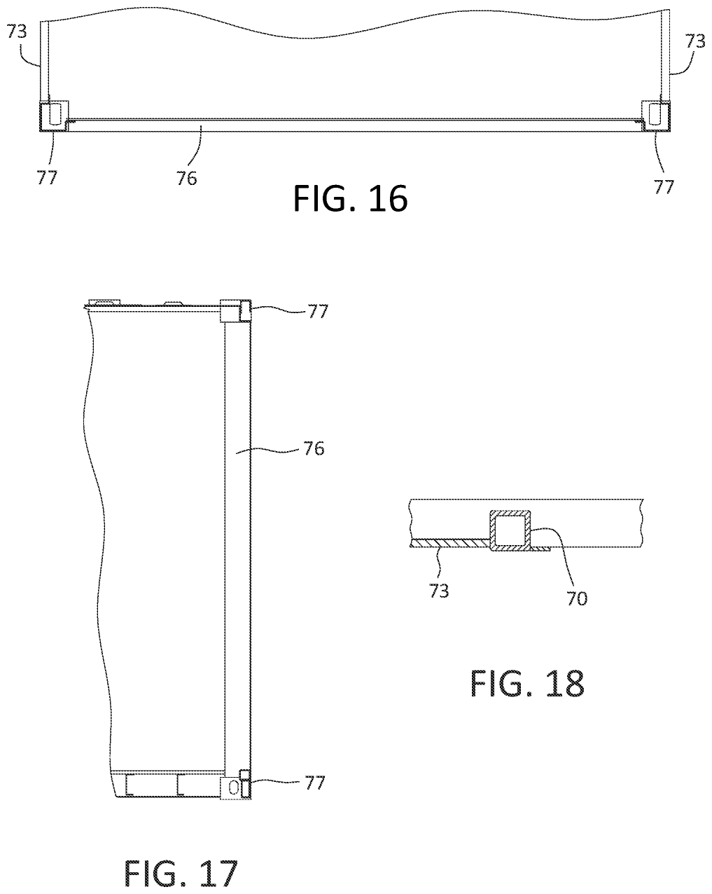

FIG. 13 shows the 45′ portion of the corridor with openings (FIG. 13, #70) on its sides where the 40′ grow rooms align. FIG. 15 shows the 45′ corridor is open on the right end (FIG. 15, #76) where the 20′ central corridor joins in the same fashion, except it is end to end.

The sizes of the buildings and width of the flanges can vary. The seal is thinner than the space between flanges initially, but expands/grows in thickness after removed from packaging.

The attached drawings are for 1¼″ space between flanges, as was the design selected in the present illustration. The reliability of the joint is increased by increasing the space between the modular containers and the width of the flanges. Alternative designs will be implemented according to the details provided herein using a wide range of sizes as disclosed here.

The two surfaces that may be joined may comprise virtually any type of surface, including painted steel surfaces.

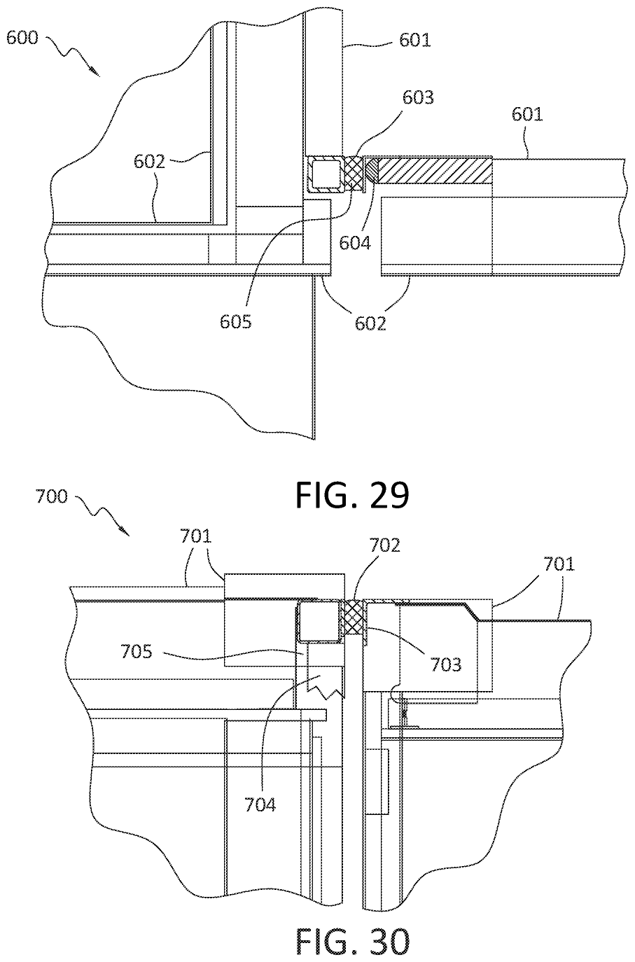

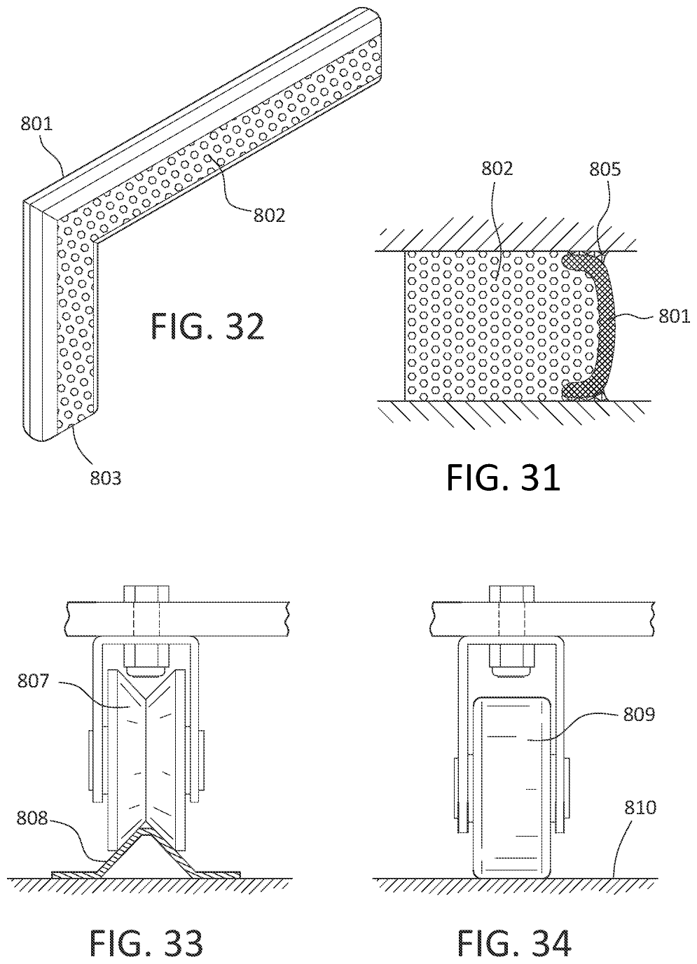

A sectional view of the seal between flanges forming the weatherproof joints is shown at FIG. 31. The flange-seal method is preferred as it permits the modular containers (buildings) to be separated easily and moved (semi-portable).

### BIBLIOGRAPHY

The following references are incorporated herein in their entirety.
1. US Pub. 2021/0298250—Quiring, et al.
2. U.S. Pat. No. 11,096,337—Wilson, et al.

What is claimed is:

1. A modular apparatus for plant cultivation comprising:
a grow table, said grow table comprising an interior space, a light source, a bottom and a top,
said bottom comprising an underside having mounted thereon a bar or structure onto which one or more wheels may be secured;
said interior space comprising a shelf suitable for placement of materials thereon; and
a modified shipping container having a floor, herein said grow table is located within the container.

2. The modular apparatus of claim 1 wherein the grow table comprises a single-tier grow table.

3. The modular apparatus of claim 1 wherein the grow table comprises a two-tier grow table.

4. The modular apparatus of claim 1 wherein the container comprises a modified shipping container.

5. The modular apparatus of claim 1 wherein said light source comprises an adjustable trellis, and said adjustable trellis comprises integrated light fixtures.

6. The modular apparatus of claim 1 wherein the floor of the modified shipping container comprises a track having a size suitable for securely accommodating wheels mounted on the bar or other structure at the underside of the grow table.

7. The modular apparatus of claim 3 wherein the two-tier grow table comprises an adjustable electronically controlled shelf.

8. A modular plant facility comprising two or more of the modular apparatus of claim 1.

9. The modular plant facility of claim 8 comprising a grow complex, wherein said grow complex comprises 1 or more modular apparatus, and said modular apparatus comprises one or more rows of a single-tier grow table.

10. The modular plant facility of claim 8 comprising a grow complex, wherein said grow complex comprises 1 or more modular apparatus, and said modular apparatus comprises one or more rows of a two-tier grow table.

11. The modular plant facility of claim 8 comprising a central corridor connecting two or more of the modular apparatus.

12. The modular plant facility of claim 8 comprising a central irrigation system.

13. The modular plant facility of claim 8 comprising an air flow monitoring and containment system, wherein air flow, temperature and light schedules within each modular apparatus may be individually controlled, and air flow within and between the modular apparatus of the facility may be individually controlled.
